(19) United States
(12) Patent Application Publication
(10) Pub. No.: US 2025/0229264 A1
(43) Pub. Date: Jul. 17, 2025

(54) METAL-ION CHELATING MATERIAL, A CHEMICAL SAMPLING DEVICE COMPRISING THE METAL-ION CHELATING MATERIAL AND A METHOD OF SYNTHESIZING THE METAL-ION CHELATING MATERIAL

(71) Applicant: NerOcean Limited, New Territories (HK)

(72) Inventors: Shiu Sun Wu, New Territories (HK); Chi Chiu Ko, New Territories (HK); Tai Chu Lau, New Territories (HK); Kwan Ngok Yu, New Territories (HK); Yi Yang, New Territories (HK); Chi On Ng, New Territories (HK); Mei Yee Leung, New Territories (HK)

(21) Appl. No.: 18/411,306

(22) Filed: Jan. 12, 2024

(51) Int. Cl. B01J 45/00; C01B 39/02; G01N 1/10; G01N 1/12

(52) U.S. Cl. CPC B01J 45/00; C01B 39/026; G01N 1/12; G01N 2001/1031

(57) ABSTRACT

A metal-ion chelating material, a chemical sampling device including the metal-ion chelating material and a method of synthesizing the metal-ion chelating material. The metal-ion chelating material includes a first binder and a second binder each arranged to chelate with a plurality of metal ions, wherein the first binder is arranged to bind with the plurality of metal ions through non-covalent interactions and the second binder is arranged to chemically bind with the plurality of metal ions through metal-ligand interactions.

### TECHNICAL FIELD

The invention relates to a metal-ion chelating material, a chemical sampling device comprising the metal-ion chelating material and a method of synthesizing the metal-ion chelating material, and particularly, although not exclusively, to a universal metal-ion chelating material for use in measuring and monitoring of metals and cations.

### BACKGROUND

Heavy metals are non-biodegradable, persistent, and can be toxic to the environment, thus causing serious environmental problems. Heavy metals tend to bioaccumulate and the extent of their bioaccumulation is dependent on the total amount, concentration and bioavailability of each metal in the environmental medium, as well as the route of uptake, storage, metabolism and excretion in biological systems. Amongst which, metal radionuclides are highly toxic and have a long environmental and biological half-life, can cause serious and long-term damages in living organisms. Radionuclides in water can be concentrated and accumulated in aquatic organisms, causing genetic mutations and cancer. Radionuclides can also bioaccumulate in the food chain, leading to higher concentrations in organisms in the higher trophic levels, including human.

As such, heavy metal ions and radionuclides in water can have detrimental effects on the environment and aquatic life. It is necessary to regularly monitor the aquatic environment and to protect the health of the ecosystem and the organisms therein. The bioaccumulation of heavy metals and radionuclides in aquatic organisms can pose a threat to both environmental and public health if the contaminated organisms are consumed.

### SUMMARY OF THE INVENTION

In accordance with the first aspect of the invention, there is provided a metal-ion chelating material comprising a first binder and a second binder each arranged to chelate with a plurality of metal ions, wherein the first binder is arranged to bind with the plurality of cations, through non-covalent interactions and the second binder is arranged to chemically bind with the plurality of metal ions through metal-ligand coordination.

In accordance with the first aspect, the first binder includes a plurality of porous cavities in a porous material.

In accordance with the first aspect, the porous material includes zeolite structure having the plurality of porous cavities arranged to bind with a plurality of metal ions.

In accordance with the first aspect, the porous material/zeolite structure comprises porous aluminosilicate.

In accordance with the first aspect, the second binder includes a plurality of chelating ligands.

In accordance with the first aspect, the porous material is chemically functionalized with a plurality of chelating ligands.

In accordance with the first aspect, the porous material is functionalized by a chemical modification process, such as silanization and/or further functionalization with different chelating ligand moieties.

In accordance with the first aspect, a plurality of chelating ligands includes N-donor and/or O-donor moieties such as amine functional group, imine functional group, carboxylate functional group, imino di(methyl acetate) functional group, an imino di(acetic acid) functional group and/or an imino di(acetate) sodium salt functional group.

In accordance with the first aspect, the plurality of ions include a plurality of cations that can fit into the porous cavities or coordinate with the chelating ligands.

In accordance with the first aspect, the plurality of cations includes a plurality of radionuclides cations of different metals or metal compounds.

In accordance with the first aspect, the plurality of cations include at least one of UO₂²⁺, Cs⁺ and Sr²⁺.

In accordance with the first aspect, the plurality of cations further include dicationic metal ions other than UO₂²⁺ and Sr²⁺.

In accordance with the first aspect, the dicationic metal ions includes at least one of Hg²⁺, Cu²⁺, Ni²⁺, Pb²⁺, Zn²⁺, CO²⁺, Cd²⁺, Fe²⁺, Mn²⁺, Ba²⁺, Ca²⁺ and other metal ions that would form coordination with iminodiacetate.

In accordance with the second aspect of the invention, there is provided a chemical sampling device comprising an enclosed cavity and the metal-ion chelating material in accordance with the first aspect contained within the enclosed cavity.

In accordance with the second aspect, the chemical sampling device is arranged to capture the plurality of metal ions in a sampling environment.

In accordance with the second aspect, the sampling environment is the aquatic environment including a marine environment, and a freshwater environment.

In accordance with the third aspect of the invention, there is provided a method of synthesizing a metal-ion chelating material, comprising the steps of silanization and/or subsequent functionalization of a zeolite structure with a plurality of chelating ligands, wherein the zeolite structure is operable to function as a first binder is arranged to bind with a plurality of metal ions through non-covalent interactions and the plurality of chelating ligands is operable to function as a second binder arranged to chemically bind with the plurality of metal ions through metal-ligand coordination.

In accordance with the third aspect, the metal-ion chelating material is fabricated by: stirring a first suspension containing EtOH—H₂O, 3-aminopropyltrimethyoxysilane and a predetermined amount of zeolite; collecting, by suction filtration, first precipitates from the first suspension after stirring; and thermal curing the first precipitates to obtain the metal-ion chelating material including a first modified zeolite comprising a silanized zeolite structure with amine functional groups.

In accordance with the third aspect, the metal-ion chelating material is fabricated by: adding, in a dropwise manner, methyl acrylate to a solution containing the first modified zeolite in MeOH to obtain a second suspension; collecting, by suction filtration, second precipitates from the second suspension after heating and stirring; and drying the second precipitates to obtain the metal-ion chelating material including a second modified zeolite structure comprising the silanized zeolite structure with amine functional groups and/or imino di(methyl acetate) functional groups.

In accordance with the third aspect, the metal-ion chelating material is fabricated by: heating and stirring a third suspension containing the second modified zeolite in formic acid; collecting, by suction filtration, third precipitates from the third suspension; and drying the third precipitates to obtain the metal-ion chelating material including a third modified zeolite structure comprising the silanized zeolite structure with amine functional groups, and/or imino di(methyl acetate) functional groups, and/or imino di(acetic acid) functional groups.

In accordance with the third aspect, the metal-ion chelating material is fabricated by: stirring a fourth suspension containing the third modified zeolite in sodium carbonate aqueous solution; collecting, by suction filtration, fourth precipitates from the fourth suspension; and drying the fourth precipitates to obtain the metal-ion chelating material including a fourth modified zeolite structure comprising the silanized zeolite structure with amine functional groups and/or imino di(methyl acetate) functional groups and/or imino di(acetic acid) functional groups, and/or imino di(acetate) sodium salt functional groups.

### BRIEF DESCRIPTION OF THE DRAWINGS

Embodiments of the present invention will now be described, by way of example, with reference to the accompanying drawings in which:

FIG. 1 is a diagram showing Preparation of functionalized porous aluminosilicate materials/zeolites, as universal cation chelating materials, in accordance with an embodiment of the present invention.

FIG. 2A is a diagram showing a silanization process of zeolite with amine functional group.

FIG. 2B is a diagram showing a functionalization process of silanized zeolite with imino di(methyl acetate) functional group.

FIG. 2C is a diagram showing a functionalization process of silanized zeolite with imino di(acetic acid) functional group.

FIG. 2D is a diagram showing a functionalization process of silanized zeolite with imino di(acetate) sodium salt functional group.

FIG. 3 is a plot showing IR spectra of unmodified and iminoacetate functionalized zeolite in the region between 1150 to 2100 cm⁻¹.

FIG. 4 is an example chemical sampling device or an artificial mussel in accordance with an embodiment of the present invention.

FIG. 5 are the plots showing absorption abilities of different metal-chelating materials for Cs⁺, UO₂²⁺, and Sr²⁺ ions at days 1, 2 and 5.

FIG. 6 is a plot showing the absorption abilities of Chelex 100 and functionalized zeolite 4 for various dicationic metal ions.

### DETAILED DESCRIPTION OF THE PREFERRED EMBODIMENTS

The inventors devised that metal-ion chelating materials, such as Chelex 100, may be used for monitoring metals and cations in the aquatic environment. For example, an artificial mussel may be equipped with Chelex 100 or other metal-ion chelating materials to bind or capture ions of different metals that exist in a sampled environment, and the captured ions may be further extracted for subsequent analysis.

However, some metal-ion chelating materials may have limitations in their ability to effectively capture or bind with a wide range of cations. Notably, radioactive cesium ions, which are common among the radionuclides produced in the nuclear fission of Uranium-based nuclear power plants, cannot be effectively chelated or captured by Chelex 100.

Although some porous materials may be able to capture cesium ions, these materials may exhibit a limited capacity to capture a wide range of metal ions and, therefore, may not be suitable for environmental monitoring applications. The inventors devised that, to effectively monitor the entire spectrum of cations/metal ions of concern, it is necessary to utilize various types of Artificial Mussels with different metal-ion chelating materials.

Moreover, multiple extraction processes and separated metal ion quantifications for different types of Artificial Mussel may be required for the quantifications of different metal ions. This would unavoidably lower the efficiency of monitoring metal ions and result in a significant increase in the monitoring cost.

To enable the capturing of a wider range of metal ions for the enhancement of the corresponding Artificial Mussel as a more effective metal-ions sampler covering the entire spectrum of metal ions and radionuclides of concern, preferably, new materials based on the functionalization of porous materials with metal-ion chelating ligand moieties may be used.

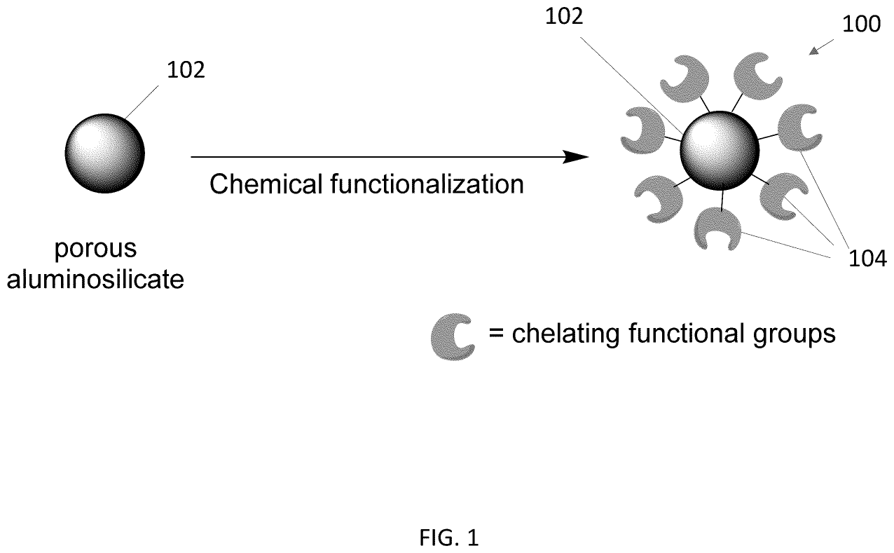

With reference to FIG. 1, there is shown an embodiment of a metal-ion chelating material 100 comprising a first binder 102 and a second binder 104 each arranged to chelate with a plurality of cations, wherein the first binder 102 is arranged to bind with the plurality of metal ions through non-covalent interactions and the second binder 104 is arranged to chemically bind with the plurality of metal ions through metal-ligand coordination.

In this disclosure, cations may include ions of metals or metal compounds, in particular ions of heavy metals or transition metals or their compounds, or ions of non-metal such as NH₄⁺. In addition, the term “metal” may be interpreted as “metal ion(s)” as commonly appreciated by person skilled in the art, such as chemists, environmental scientists or engineers.

In this embodiment, the first binder 102 includes porous aluminosilicate, which has a zeolite structure. Zeolites are crystalline aluminosilicates that have a porous material and a high surface area, thus having a plurality of porous cavities arranged to bind with a plurality of metal ions through non-covalent interactions, and may be used to capture metal ions, such as radioactive cesium ions, from aqueous solutions.

Preferably, the zeolite structure contains donor atoms, such as N-donor and/or O-donor moieties, that can bind cations such as cesium ion through non-covalent interactions.

During operation, cations or metal ions such as cesium ions can bind inside the pores of the zeolites. The selectivity of zeolites for metal ions such as cesium ions is due to the size of the cesium ion, which may be similar to the size of the pores in the zeolite structure. Therefore, selective binding/capturing towards particular cations of concern can be achieved by choosing a suitable type of zeolites. Advantageously, the removal of cesium ions from aqueous solutions using zeolites is an effective method to remove a radioactive isotope of cesium, Cs-137, even present in low concentration in seawater or other samples.

Alternatively, the plurality of metal ions includes a plurality of radionuclides and their cations, such as but not limited to, uranium-238, thorium-232, potassium-40 and radium-226, in which their ions are monocationic. In addition, other types of porous silicate/silica material may also be used, as long as the porous material may be chemically modified as further described below.

Preferably, the metal-ion chelating material further comprises a second binder 104 arranged to bind or capture other metal ions, such as but not limited to UO²⁺, Sr²⁺, Hg²⁺, Cu²⁺, Ni²⁺, Pb²⁺, Zn²⁺, Co²⁺, Cd²⁺, Fe²⁺, Mn²⁺, Ba²⁺ and Ca²⁺. These are examples of dicationic metal ions or heavy metal cations that may be chemically captured by the metal-ion chelating material, preferably by special functional groups functionalized on the metal-ion chelating material.

For example, the zeolite structure is chemically functionalized by the plurality of chelating ligands. Thus, the modified zeolite structure has the chelating ligands functioning as a second binder to chemically chelate or bind with metal ions of specific types, such as heavy metals that are usually polyvalent transition metals and are usually toxic to aquatic organisms. Preferably, the chelating ligands may contain iminodiacetate moieties, which may act as chelating groups in binding polyvalent metal ions.

Referring to FIG. 1, the zeolite structure may be modified or chemically functionalized by a suitable chemical modification process, such as silanization, so as to “anchor” the desired functional groups to the surface of a zeolite structure. Optionally, the silalized zeolite structure may be further chemically modified by subsequent functionalization with different chelating ligand moieties, so as to anchor different functional groups for chelating desired cations.

In this example, the silanization reaction of the porous materials with silanes having functional groups for chemical functionalization together with the subsequent chemical functionalization are used to prepare/fabricate the metal-ion chelating material. Advantageously, as both the chelating functional groups (ligands) and the porous cavities are capable of binding with different types of cations, cation-chelating materials having both porous cavities and chelating ligands are capable of binding with a wider range of metal ions compared with materials having only the porous cavities or the chelating ligands in other example materials.

Preferably, the plurality of chelating ligands or second binder 104 includes at least one of an amine functional group, carboxylate group, imine group, an imino di(methyl acetate) functional group, an imino di(acetic acid) functional group, and/or an imino di(acetate) sodium salt functional group. The selectivity of the modified zeolite structure depends on the choices of functional groups being anchored to the zeolite structure and/or types of zeolite.

The inventors devised that a similar design strategy could be applied to other porous materials and chelating functional groups, in addition, apart from silanization and subsequent functionalization, other chemical modification reactions of materials can be applied to afford other similarly designed metal-ion/cation chelating materials.

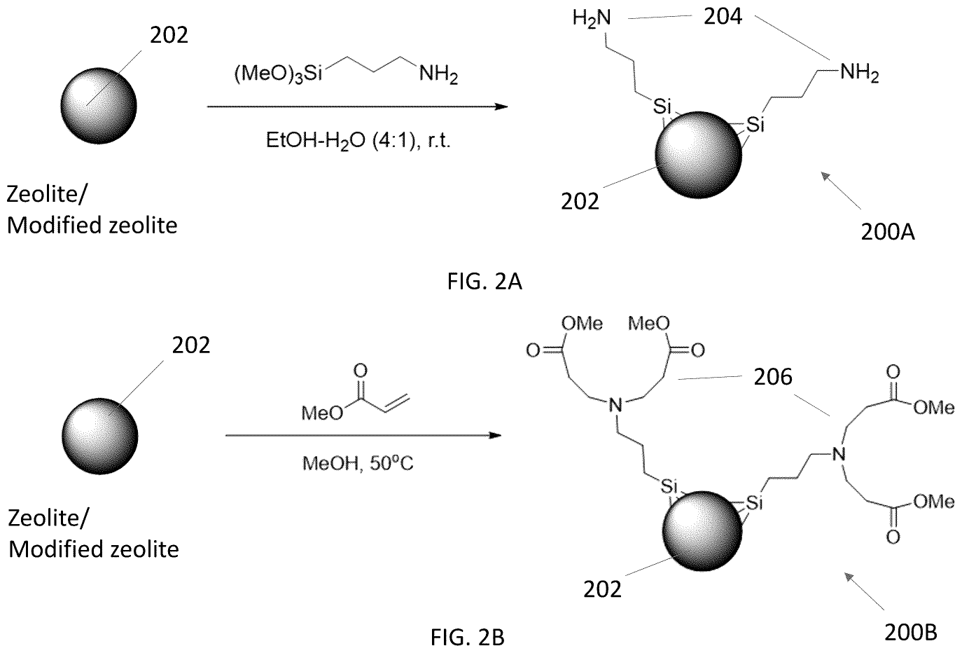

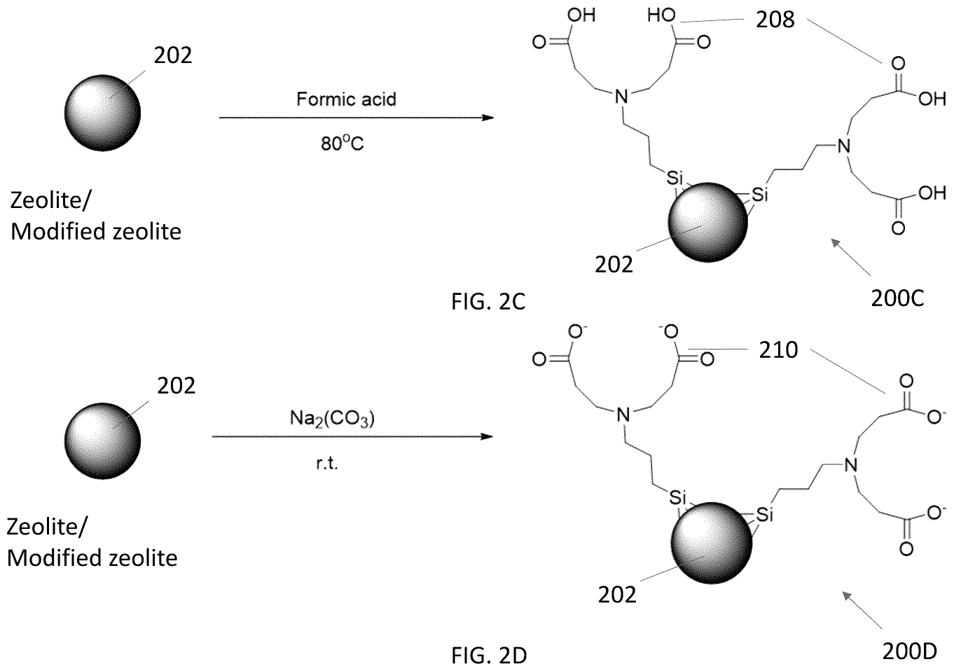

With reference also to FIG. 2A, zeolite 202 may be silanized with amine functional group 204, by stirring a suspension containing EtOH—H₂O, 3-aminopropyltrimethyoxysilane and a predetermined amount of zeolite; collecting, by suction filtration, precipitates from the suspension after stirring; and thermal curing the precipitates to obtain the metal-ion chelating material including a first modified zeolite 200A comprising a silanized zeolite structure 202 with amine functional groups 204.

In one example embodiment, to a 50 ml EtOH—H₂O (4:1. v/v) solution with 3-aminopropyltrimethyoxysilane (APTMS, 6.4 ml, 35.7 mmol), a specific type of zeolite (11.9 g, 73.3 mmol) may be added to give a suspension. After stirring at room temperature for 3 hours, the brown precipitates may be collected by suction filtration. After washing with EtOH (20 ml×3) and subsequently incubated at 110° C. for thermal curing of the silanized materials, the cured solid may be washed with EtOH (20 ml×3) and dried at 70° C. for 15 hours. Silanized zeolite 1 (i.e. the first modified zeolite) may be obtained as a brown powder (Yield: 10.5 g). IR (KBr disk, cm⁻¹): 3281 br, 1644, 1483 (N-H bending), 1483, 1423, 1197, 1108, 1057, 990.

Alternatively, or additionally, zeolite may be silanized with imino di(methyl acetate) functional groups, imino di(acetic acid) functional groups and/or imino di(acetate) sodium salt functional groups. For example, referring to FIG. 2B, silanized zeolite 202 or modified zeolite may be functionalized with imino di(methyl acetate) functional groups 206 by adding, in a dropwise manner, methyl acrylate (MA) to a solution containing the (modified) zeolite in MeOH to obtain a suspension; collecting, by suction filtration, precipitates from the suspension after heating and stirring; and drying the precipitates to obtain the metal-ion chelating material 200B including a silanized zeolite structure 202 (further) with imino di(methyl acetate) functional groups 206.

For example, to a solution of first modified zeolite (10 g) in MeOH (40 mL) at 0° C., methyl acrylate (24.0 ml, 264 mmol) may be added in a dropwise manner. The resulting mixture may be warmed to 80° C. and stirred at this temperature for 24 hours. After cooling to room temperature, the light brown precipitate may be collected by suction filtration and washed with EtOH (20 ml×3). After drying at 70° C. for 15 hours, a second modified zeolite (i.e. zeolite 2) may be obtained as light brown power (Yield: 11.7 g). IR (KBr disk, cm⁻¹): 3296 br, 1738 (C═O stretching), 1642, 1585, 1469, 1417, 1317 (C—O stretching), 1192, 1103, 1050, 989, 880, 797, 747, 699, 674. In this example, the second modified zeolite structure 200B comprises a silanized zeolite structure 202 with amine functional groups 204 and further functionalized with imino di(methyl acetate) functional groups 206.

Alternatively, if unmodified zeolite is modified by these silanization and functionalization processes, a different modified zeolite may be obtained where it is only functionalized with imino di(methyl acetate) functional groups.

Referring to FIG. 2C, zeolite 202 or modified zeolite may be functionalized with imino di(acetic acid) functional groups 208 by heating and stirring a suspension containing a zeolite or a modified zeolite in formic acid; collecting, by suction filtration, precipitates from the suspension; and drying the precipitates to obtain the metal-ion chelating material 200C including a zeolite structure 202 (further) functionalized with imino di(acetic acid) functional groups 208.

A suspension of zeolite 2 (10 g) in formic acid (60 mL) may be heated to 80° C. and stirred for 12 hours. The resulting mixture may be cooled to room temperature. The resulting brown precipitate may be collected by suction filtration and subsequently washed with deionized water (20 ml×5) and EtOH (20 ml×3). After drying at 70° C., zeolite 3 (i.e. a third modified zeolite) may be obtained as a brown powder (Yield: 8.64 g). IR (KBr disk, cm⁻¹): 3406 br, 1725 (C═O stretching), 1708, 1632, 1587, 1534, 1511, 1473, 1447 (C—H bending), 1412 (O—H bending), 1380 (C—H bending), 1357, 1313 (C—O stretching), 1160, 1053, 965, 882, 797. In this example, the third modified zeolite structure 200C comprises a silanized zeolite structure 202 with amine functional groups 204 and/or imino di(methyl acetate) functional groups 206, and further functionalized with imino di(acetic acid) functional groups 208.

Alternatively, if unmodified zeolite is modified by these silanization and functionalization processes, a different modified zeolite may be obtained where it is only functionalized with imino di(acetic acid) functional groups.

Referring to FIG. 2D, zeolite 202 or modified zeolite may be functionalized with imino di(acetate) sodium salt functional groups 210 by stirring a suspension containing the zeolite or modified zeolite in sodium carbonate aqueous solution; collecting, by suction filtration, precipitates from the suspension; and drying the precipitates to obtain the metal-ion chelating material 200D including a silanized zeolite structure 202 with imino di(acetate) sodium salt functional groups 210.

For example, a suspension of zeolite 3 (5 g) in 2M sodium carbonate aqueous solution (100 ml) may be stirred vigorously at room temperature for 24 hours. The brown precipitate may be collected by suction filtration. After drying at 70° C. for 15 hours, zeolite 4 or the fourth zeolite structure may be obtained as a light brown powder (2.29 g). IR (KBr disk, cm⁻¹): 3383 br, 1703 (C═O stretching), 1667, 1642, 1544, 1498, 1465 (C—H bending), 1406 (C—H bending), 1343 (C—O stretching), 1199, 1037, 960, 784, 665. In this example, the fourth modified zeolite structure 200D comprises a silanized zeolite structure 202 with amine functional groups 204 and/or imino di(methyl acetate) functional groups 206 and/or imino di(acetic acid) functional groups 208, and further functionalized with imino di(acetate) sodium salt functional groups 210.

Alternatively, if unmodified zeolite is modified by these silanization and functionalization processes, a different modified zeolite may be obtained where it is only functionalized with imino di(acetate) sodium salt functional groups.

It should be appreciated by a skilled person in the art that the combination of modification of the zeolite structure or material with N-donors and/or O-donors such as an amine functional group, an imine group, a carboxylate group, an imino di(methyl acetate) functional group, an imino di(acetic acid) functional group, and an imino di(acetate) sodium salt functional group may be selectively chosen by modifying the zeolite structure with two or more of these modification processes, depending on the desired range of metal ions that the chelating material is designed to work with. For example, zeolite structure 202 functionalized with imino di(methyl acetate) functional groups 206 and/or imino di(acetic acid) functional groups 208 may be obtained, by modifying the zeolite structure 202 according to the processes illustrated in FIGS. 2B and 2C. In addition, process parameters such as stirring, heating/drying/curing temperature, and reaction duration may be changed according to different process setups and/or desired material compositions during fabrication.

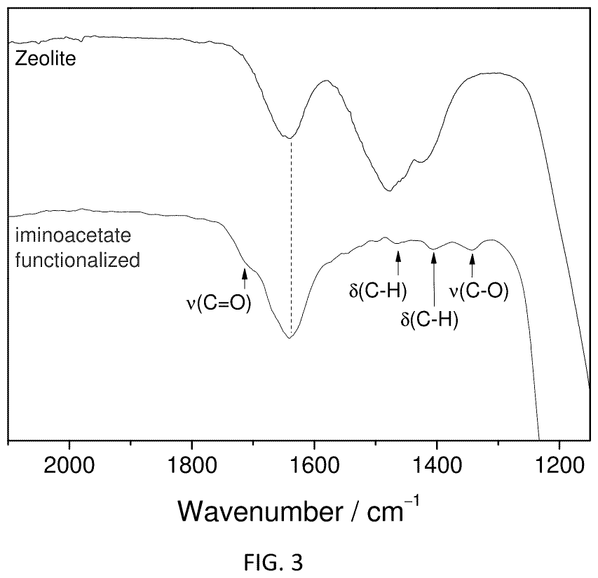

With reference to FIG. 3, it shows the IR spectra of unmodified and iminoacetate functionalized zeolite, zeolite 4 as described above, in the region between 1150 to 2100 cm⁻¹, where the dotted lines denote the signals of zeolite. For clarity, the stretching and bending modes of iminoacetate functional groups of iminoacetate functionalized zeolite are shown as ν and δ, respectively, in the labelled IR peaks.

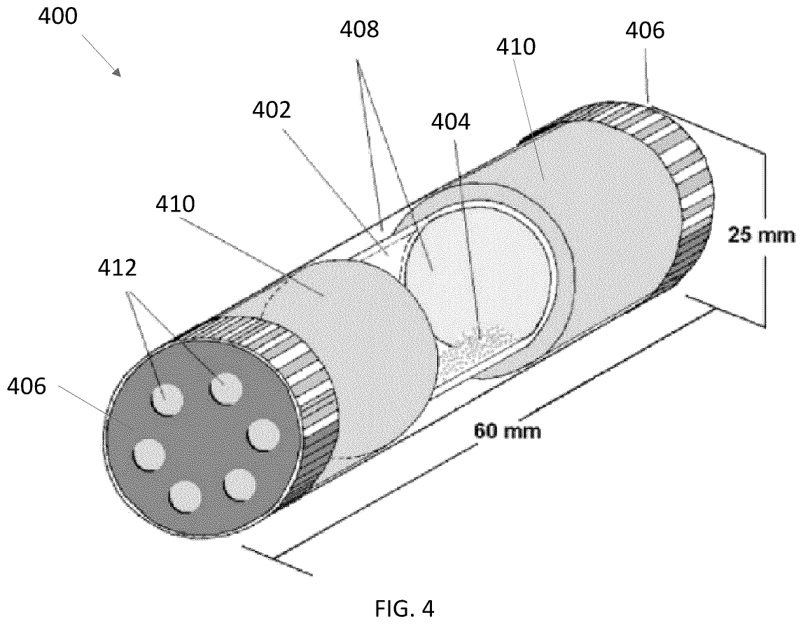

With reference to FIG. 4, there is shown an embodiment of a chemical sampling device 400 comprising an enclosed cavity 402 and the metal-ion chelating material 404 contained within the enclosed cavity 402. In this embodiment, the chemical sampling device 400 comprises protective caps 406 enclosing a tube 408 housing two layers (e.g. of 1 cm thick) of polyacrylamide gel 410 sandwiching an enclosed cavity 402 containing a certain amount of metal-ion chelating material 404. The tube 408 may be of 25 mm diameter and 60 mm in length. The protective caps 406 are provided with openings 412 which allow fluidic communication of metal-ion chelating material 404 to be in contact with the seawater or freshwater surrounding the device 400, such that the chemical sampling device may capture the plurality of metal ions in a sampling environment, similar to an “artificial mussel” working in a marine environment or other sampling environment. For example, the chemical sampling device 400 may be used for monitoring ²³⁸U, ⁸⁸Sr, and ¹³³Cs in aquatic environment, by carrying out an “uptake (and accumulation) and release” process of the cations in the sampled environment.

The inventors devised that mussels have a remarkable ability to accumulate radionuclides and metals from both water and planktonic food and therefore may be employed to monitor radionuclides and metals in aquatic environments. However, both the uptake and retention of radionuclides and metals in mussels may be affected by the prevailing physical factors in the environment (e.g., salinity, temperature, food availability) and biological factors (e.g., seasonal growth and reproductive conditions). For example, it was found that no seasonal variation of radionuclide concentrations in seawater along the Atlantic coast of Portugal, and yet, marked seasonal changes in²¹⁰Po and ²¹⁰Pb were clearly evident in mussels during the same period, which was attributable to changes in body weight and the concentrations of lipophilic compounds in the mussels. These confounding factors may make it very difficult, if not impossible, to compare the levels of radionuclides and metals in mussels under different hydrographic conditions over time. More importantly, the limited distribution of mussel species in the natural environment often prevents comparisons over large areas.

In contrast, the passive sampler ‘Artificial Mussel’ (AM) may be used as a rapid and cost-effective chemical sampling device for monitoring radionuclides and metals in the environment. Advantageously, ‘Artificial Mussel’ can provide a time-integrated estimate of metal concentrations in marine and freshwater environments. In addition, AMs can provide a reliable time-integrated estimate of a variety of metals over large biogeographic areas with very different hydrological conditions and therefore overcome the longstanding problems of monitoring metals in water, sediment, and biomonitors. Moreover, AMs can also take up U from water, alongside other metal species, despite U not being detected in native mussels deployed at the same site.

The inventors also devised that, for monitoring radionuclides in aquatic environments, it is crucial that AMs fulfill the following three criteria: (a) able to concentrate radionuclides at environmentally relevant concentrations from the environment; (b) the accumulation, uptake, and release of radionuclides are directly related to the concentration of radionuclides in the water; and (c) both the uptake and release of any individual radionuclides are not significantly affected by the presence of other radionuclides in the environment.

Chemical analysis of the metals and radionuclides concentrated by AM from the sampled environment may be carried out as follows. In one example operation, metal-ion chelating material of each individual AM may be emptied into a sintered glass filter and eluted after rinsing three times with 12.5 mL 6 M HNO₃ (analytical grade). The seawater sample and the elutriate solution may then be made up to a known volume with deionized double-distilled water, and concentrations of the captured metals, e.g. ²³⁸U, ⁸⁸Sr, and ³³Cs, in the elutriate solution may be determined using an Optima 8000 ICP-OES and NexION 2000 ICP-MS (Plasma flow: 15 L/min; auxiliary flow: 0.3 L/min; nebulizer flow: 0.8 L/min; RF power: 1300 W, pump rate: 1.0 mL/min) after calibration using a standard solution (1000 mg/mL in 2% HNO₃). In this detection setup, the detection limit may be 0.1 μg/g for ⁸⁸Sr, ³³Cs, and ²³⁸U. The accuracy of the analysis may then be evaluated by measuring replicate samples and determined by standard calibration curves with 1, 10, 25, 50, 100, 500, and 1000 μg/L.

The binding studies of metal Ions (Cs⁺, Sr²⁺ and UO₂²⁺) having concerns about their radioactive isotopes were conducted by submerging (100 mg) of metal-ion chelating materials, including commercially available metal-chelating materials (Chelex 100), porous materials Zeolite before chemical modification, or the new iminoacetate functionalized zeolite 4 (i.e. the fourth modified zeolite) as described earlier, into the 25 mL aqueous solution of cesium (Cs⁺, 1.5 ppb, Cs₂CO₃), uranium (UO₂²⁺, 15 ppb, UO₂(OAc)₂) and strontium (Sr²⁺, 50 ppm, SrCl₂) in DI water. The metal ion concentrations of the solutions were determined at days 0, 1, 2, and 5 by ICP-MS.

To evaluate the binding affinities of the iminoacetate-functionalized zeolite 4 in comparison with Chelex-100, the study has assessed the capture efficiency for a range of metal ions, including Hg²⁺, Cu²⁺, Ni²⁺, Pb²⁺, Zn²⁺, Co²⁺, Cd²⁺, Fe²⁺, Mn²⁺, Ba²⁺, and Ca²⁺ ions. This was accomplished by quantifying the reduction in concentrations of these metal ions from day 0 to day 5 after submerging the materials into the solutions of each metal ion, thereby providing a comparative analysis of the metal sequestration capabilities of 4 and Chelex-100.

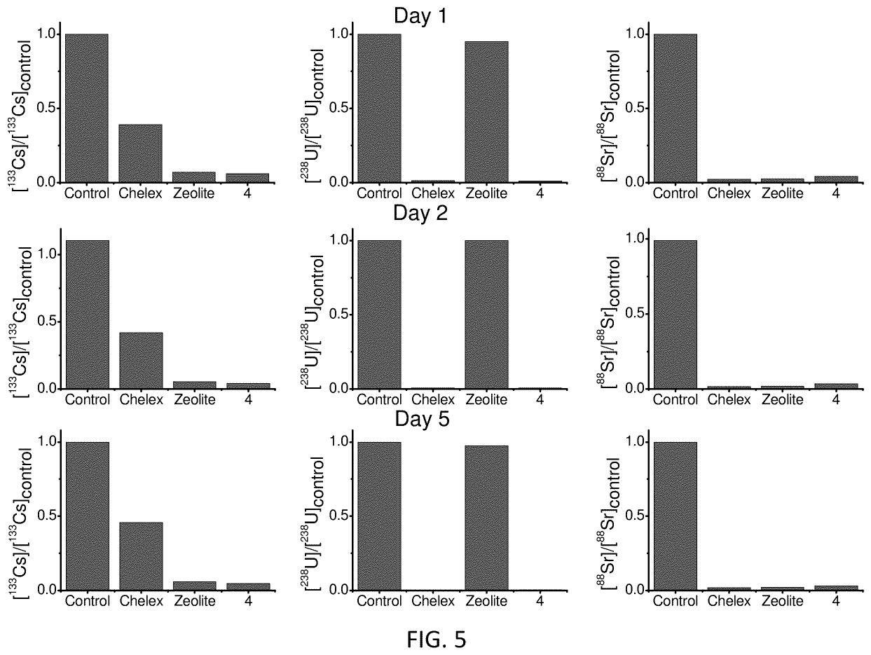

Referring to FIG. 5, for UO₂²⁺, Cs⁺ and Sr²⁺ ions, Chelex-100 showed high binding affinity to UO²⁺ and Sr²⁺ ions but poor affinity to Cs⁺ ions. This is consistent with the poor metal-binding affinity of Chelex-100 with monocationic metal ions. Zeolite showed a high binding affinity to Cs⁺ and Sr²⁺ ions but a poor binding affinity to UO₂²⁺ ions. The poor binding affinity of Zeolite towards UO₂²⁺ can be attributed to the mismatch between the ion size and the pore of Zeolite.

In contrast, for the iminoacetate functionalized zeolite 4, it showed high binding affinity to Cs⁺, UO₂²⁺, and Sr²⁺ ions. This is due to the synergistic effect of the binding interactions of the pores and the iminoacetate moieties that are covalently linked to the porous materials. As a result, the iminoacetate functionalized zeolite 4 can bind monocationic metal ions and ions with their sizes not fitting well in the pores in the porous material.

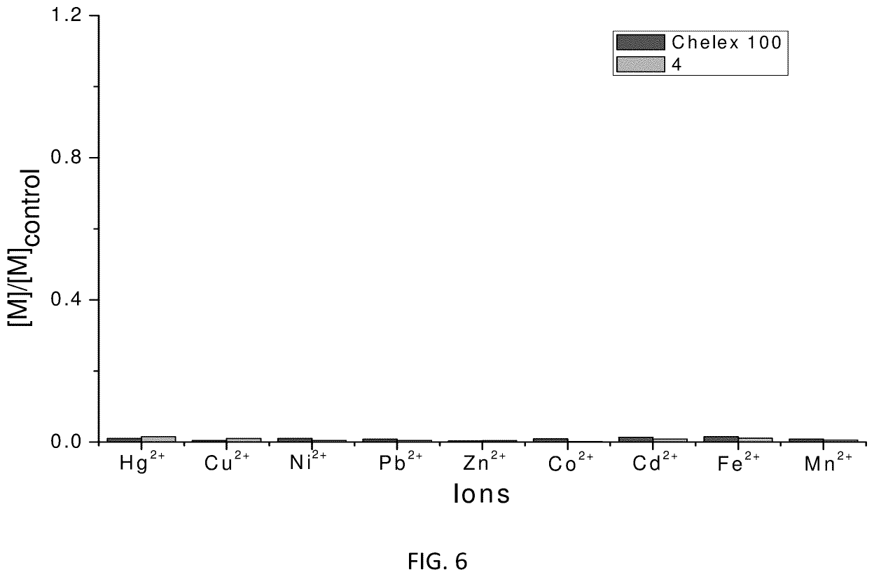

With reference to FIG. 6, for other dicationic metal ions, comparing with Chelex-100, the iminoacetate functionalized zeolite 4 also binds with those ions that are reported to bind with Chelex-100. These results confirm that significantly more diverse metal ions and cations can be captured by the porous materials functionalized with iminoacetate functional moieties.

In addition, further modification of the binding capabilities and capacities can be tuned using different types of porous materials and metal-ion binding functional groups. Advantageously, artificial Mussels equipped with universal metal-ion chelating materials, namely metal-ion binding moieties functionalized porous materials, can serve as an effective tool for monitoring a wide spectrum of ions of radionuclides and heavy metal ions.

These embodiments may be advantageous in that monitoring pollution in the aquatic environment, e.g. by using the chemical sampling device and the metal-ion chelating material in accordance with the embodiments described above, can help identify the sources of pollution and the extent of contamination, which can aid in the development of effective mitigation strategies. In addition, it may be useful to monitor directly the source of pollutant, such as where radioactive pollutants from nuclear plants are discharged to the water, to evaluate the impact to the aquatic environment and/or to the aquatic organisms.

Moreover, monitoring the heavy metal ions and/or ions of radionuclides can also provide context to environmental science and allow the development of a critical scientific understanding of the aquatic environment and the impacts that humans are having on it.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive. Any reference to prior art contained herein is not to be taken as an admission that the information is common general knowledge, unless otherwise indicated.

1. A metal-ion chelating material comprising a first binder and a second binder each arranged to chelate with a plurality of metal ions, wherein the first binder is arranged to bind with the plurality of cations through non-covalent interactions and the second binder is arranged to chemically bind with the plurality of metal ions through metal-ligand coordination.

2. The metal-ion chelating material in accordance with claim 1, wherein the first binder includes a plurality of porous cavities in a porous material.

3. The metal-ion chelating material in accordance with claim 2, wherein the porous material includes zeolite structure having the plurality of porous cavities arranged to bind with the plurality of metal ions through non-covalent interactions.

4. The metal-ion chelating material in accordance with claim 3, wherein the zeolite structure comprises porous aluminosilicate.

5. The metal-ion chelating material in accordance with claim 4, wherein the second binder includes a plurality of chelating ligands.

6. The metal-ion chelating material in accordance with claim 5, wherein the zeolite structure is chemically functionalized by the plurality of chelating ligands.

7. The metal-ion chelating material in accordance with claim 6, wherein the zeolite structure is functionalized by a chemical modification process.

8. The metal-ion chelating material in accordance with claim 6, wherein the plurality of chelating ligands includes an imine functional group, a carboxylate functional group, an amine functional group, an imino di(methyl acetate) functional group, an imino di(acetic acid) functional group and/or an imino di(acetate) sodium salt functional group.

9. The metal-ion chelating material in accordance with claim 1, wherein the plurality of metal ions includes a plurality of cations of different metals or metal compounds, and/or radionuclides.

10. The metal-ion chelating material in accordance with claim 9, wherein the plurality of metal ions include at least one of UO₂²⁺, Cs⁺ and Sr²⁺.

11. The metal-ion chelating material in accordance with claim 10, wherein the plurality of metal ions further include dicationic metal ions other than UO₂²⁺ and Sr²⁺.

12. The metal-ion chelating material in accordance with claim 11, wherein the dicationic metal ions include at least one of Hg²⁺, Cu²⁺, Ni²⁺, Pb²⁺, Zn²⁺, Co²⁺, Cd²⁺, Fe²⁺, Mn²⁺, Ba²⁺ and Ca²⁺.

13. A chemical sampling device comprising an enclosed cavity and the metal-ion chelating material in accordance with claim 1 contained within the enclosed cavity.

14. The chemical sampling device in accordance with claim 13, wherein the chemical sampling device is arranged to capture the plurality of metal ions in a sampling environment.

15. The chemical sampling device in accordance with claim 14, wherein the sampling environment includes a marine environment or freshwater environment.

16. A method of synthesizing a metal-ion chelating material, comprising the steps of silanizing and/or further functionalization of a zeolite structure with a plurality of chelating ligands, wherein the zeolite structure is operable to function as a first binder is arranged to bind with a plurality of metal ions through non-covalent interactions and the plurality of chelating ligands is operable to function as a second binder arranged to chemically bind with the plurality of metal ions through metal-ligand coordination.

17. The method in accordance with claim 16, wherein the metal-ion chelating material is fabricated by:
stirring a first suspension containing EtOH—H₂O, 3-aminopropyltrimethyoxysilane and a predetermined amount of zeolite;
collecting, by suction filtration, first precipitates from the first suspension after stirring; and
thermal curing the first precipitates to obtain the metal-ion chelating material including a first modified zeolite comprising a zeolite structure silanized with amine functional group.

18. The method in accordance with claim 17, wherein the metal-ion chelating material is fabricated by:
adding, in a dropwise manner, methyl acrylate to a solution containing the first modified zeolite in MeOH to obtain a second suspension;
collecting, by suction filtration, second precipitates from the second suspension after heating and stirring; an
drying the second precipitates to obtain the metal-ion chelating material including a second modified zeolite structure comprising the zeolite structure silanized with amine functional groups and/or imino di(methyl acetate) functional groups.

19. The method in accordance with claim 18, wherein the metal-ion chelating material is fabricated by:
heating and stirring a third suspension containing the second modified zeolite in formic acid;
collecting, by suction filtration, third precipitates from the third suspension; and
drying the third precipitates to obtain the metal-ion chelating material including a third modified zeolite structure comprising the zeolite structure silanized with amine functional groups, imino di(methyl acetate) functional groups, and/or imino di(acetic acid) functional groups.

20. The method in accordance with claim 19, wherein the metal-ion chelating material is fabricated by:
stirring a fourth suspension containing the third modified zeolite in sodium carbonate aqueous solution;
collecting, by suction filtration, fourth precipitates from the fourth suspension; and
drying the fourth precipitates to obtain the metal-ion chelating material including a fourth modified zeolite structure comprising the zeolite structure silanized with amine functional groups imino di(methyl acetate) functional groups, imino di(acetic acid) functional groups, and/or imino di(acetate) sodium salt functional groups.
